(19) United States
(12) Patent Application Publication
(10) Pub. No.: US 2013/0159067 A1
(43) Pub. Date: Jun. 20, 2013

(54) EQUILAR PAY FOR PERFORMANCE SCORE

(71) Applicant: Equilar, Inc., Redwood City, CA (US)

(72) Inventors: Andrew Comstock, Menlo Park, CA (US); Brian Sohmers, Los Altos, CA (US); David Chun, Palo Alto, CA (US); David Sasaki, San Francisco, CA (US); Nancy Ho, San Jose, CA (US); Andrew Gordon, San Francisco, CA (US)

(73) Assignee: Equilar, Inc., Redwood City, CA (US)

(21) Appl. No.: 13/707,241

(22) Filed: Dec. 6, 2012

Related U.S. Application Data
(60) Provisional application No. 61/568,647, filed on Dec. 8, 2011.

(51) Int. Cl. G06Q 10/06; G06Q 40/00

(52) U.S. Cl. CPC G06Q 10/06393; G06Q 40/105
USPC 705/7.39

(57) ABSTRACT

Techniques are provided for generating an objective metric (a “pay-for-performance” score) that can be used to determine whether an executive at a target company is underpaid or overpaid, relative to executives at similarly-situated companies, based on executive compensation information, the performance the target company, and the performance of the similarly-situated companies. The executive may be, for example, the CEO of the target company. In general, the pay-for-performance score measures the difference between a company's CEO pay relative to a group of peers and the company's performance relative to the same group of peers.

### CROSS-REFERENCE TO RELATED APPLICATIONS; BENEFIT CLAIM

This application claims the benefit of U.S. Provisional Application No. 61/568,647, filed Dec. 8, 2011, the entire contents of which is hereby incorporated by reference as if fully set forth herein, under 35 U.S.C. §119(e).

### FIELD OF THE INVENTION

The present invention relates to computerized techniques for generating an objective metric that reflects the pay received by executive officers relative to the performance of their respective companies.

### BACKGROUND

To a variety of people, including company executives, directors, investors and analysts, the ability to make informed decisions about a company is critical. Too often, such decisions are more a product of guesswork, gut feelings, or efforts to maintain the status quo, rather than objectively-measurable criteria. An example of such a decision is the decision of how much compensation should be paid to company executives. Overpaying company executives reduces shareholder profits and may lead to negative publicity. Underpaying company executives reduces the chances of obtaining and retaining the best-qualified executives.

In general, most agree that an executive's pay should be commensurate with their performance, as reflected by the company's performance under their direction. However, given the diversity of companies, markets, services and products, it is difficult to translate the general notion that pay should be commensurate with performance into an actual, objective, pay-for-performance measure by which executives may be compared.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIGS. 1A and 1B illustrate formulas for generating pay-for-performance scores, according to embodiments of the invention;

FIG. 2 illustrates a formula for calculating Total Shareholder Return (“TSR”), according to an embodiment;

FIG. 3A illustrates dividends made by a sample company;

FIG. 3B illustrates stock prices of the sample company;

FIG. 4A illustrates a formula for calculating Return on Equity, according to one embodiment;

FIG. 4B illustrates a formula for calculating Revenue Growth, according to one embodiment;

FIG. 5 illustrates a formula for generating a pay factor for an executive, according to an embodiment;

FIG. 6 illustrates an alternative technique for generating a pay factor for an executive, according to an alternative embodiment;

FIG. 7 illustrates yet another technique for generating a pay factor for an executive, according to an alternative embodiment;

FIG. 8 is a block diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are described herein for generating an objective metric (a “pay-for-performance” score) that can be used to determine whether an executive at a target company is underpaid or overpaid, relative to executives at similarly-situated companies, based on executive compensation information, the performance of the target company, and the performance of the similarly-situated companies. For the purposes of illustration, it shall be assumed that the executive officer for which the metric is generated is the CEO of the target company. However, the techniques described herein may be adapted for use with any particular executive role for any type of entity. The types of entities for which the techniques may be used include, but are not limited to, companies, portions of companies (e.g. a branch, subsidiary, etc.), or other types of organizations (clubs, non-profit organizations, etc.). In general, the pay-for-performance score measures the difference between an entity's executive's pay relative to a group of peers and the entity's performance relative to the same group of peers.

### Peer Identification

As a preliminary step to generating a pay-for-performance score for the CEO of a particular company, companies that are “peers” to the particular company are identified. For the purposes of generating a pay-for-performance score, any one of a number of techniques may be used to identify which companies qualify as peers of a given company.

One technique for identifying peer companies is described in U.S. patent application Ser. No. 13/620,074, filed Sep. 14, 2012, the contents of which are incorporated herein in their entirety. Those techniques involve identifying peers based on company-to-company relationships, such as compensation benchmarking peer groups reported in SEC filings.

Alternative techniques for identifying peers may make use of any number of other sources, such as the Global Industry Classification Standard (GICS), which maps companies to 10 sectors, 24 industry groups, 68 industries and 154 sub-industries. The techniques described herein for generating pay-for-performance scores are not limited to any particular technique or source for identifying peers.

### Pay-For-Performance Calculation

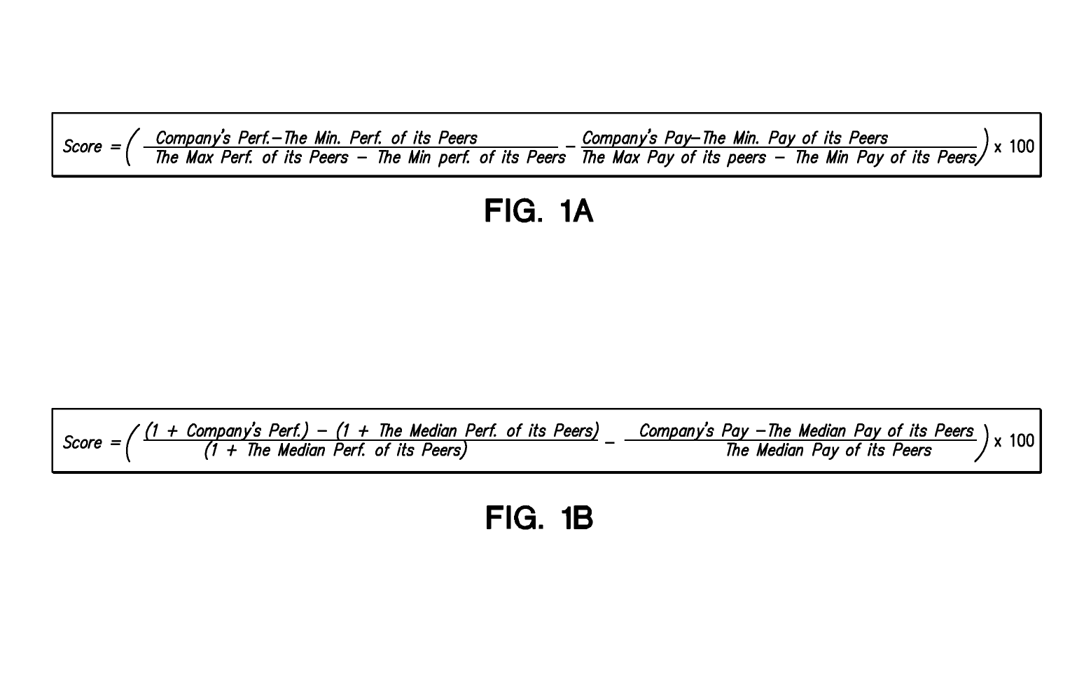

Once the peers of a company have been identified, the pay-for-performance score may be generated by a computer system for a particular executive of a particular company based on information about the particular executive's compensation, information about the particular company's performance, and similar information about executive pay and performance of the peer companies. Specifically, FIG. 1A illustrates a formula for generating a pay-for-performance score for the executive of a company (the “target company”) according to one embodiment.

Referring to FIG. 1A, the pay-for-performance score (the “score”) is calculated by subtracting a second fraction from a first fraction, and multiplying the results by 100. In the embodiment illustrated in FIG. 1A, the first fraction is generated by subtracting the minimum performance of the peer companies from the target company's performance, and dividing that by the maximum performance of the peer companies minus the minimum performance of the peer companies.

The second fraction is generated by subtracting the minimum pay of the peer companies from the pay of the target company's executive, and dividing that value by the maximum pay of the peer companies minus the minimum pay of the peer companies.

The various operands illustrated in FIG. 1A refer to “performance” or “pay”. Various objective measures may be used to calculate the performance of companies and the pay of company executives. The various measures used to represent performance and pay may vary from implementation to implementation, and the formula illustrated in FIG. 1A is not limited to any particular “performance” or “pay” measures.

### Alternative Pay-For-Performance Calculation

Referring to FIG. 1B, it illustrates a formula for generating a pay-for-performance score according to an alternative embodiment. Rather than make use of the pay and performance values of the minimum and maximum peers, the formula in FIG. 1B uses the median performance of the target company's peers.

Similar to the formula illustrated in FIG. 1A, the formula shown in FIG. 1B calculates the pay-for-performance score by subtracting a second fraction from a first fraction, and multiplying the results by 100. In the embodiment illustrated in FIG. 1B, the first fraction is generated by subtracting the median performance of the peer companies from the target company's performance, and dividing that by 1 plus the median performance of the peer companies.

The second fraction is generated by subtracting the median pay of the peer companies from the pay of the target company's executive, and dividing that value by the median pay of the peer companies.

FIGS. 1A and 1B merely represent two alternative ways by which a pay-for-performance score may be automatically generated based on information about the pay of an executive of a target company, the performance of the target company, and similar pay and performance information from peers of the target company. Thus, the techniques described herein are not limited to any particular formula for generating the pay-for-performance score.

### Company Performance Measures

As explained above, the pay-for-performance score is generated based on pay and performance information from a target company and from the target company's peers. Various objective factors may be used to generate a value that indicates a company's overall performance. In general, the performance value of a company serves as a measure of how well/poorly the company has performed financially in recent years. There are many different ways of calculating performance. In one embodiment, performance is calculated based on Total Shareholder Return (“TSR”), which is a measure of stock price growth.

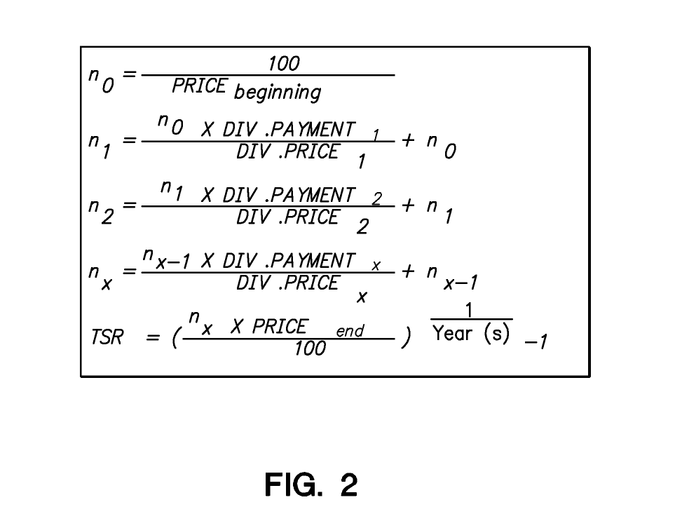

Referring to FIG. 2, it illustrates a formula for calculating TSR over a three year period, with dividends reinvested. The raw data points for the formula illustrated in FIG. 2 include stock prices, dividend payments, and dividend payment dates.

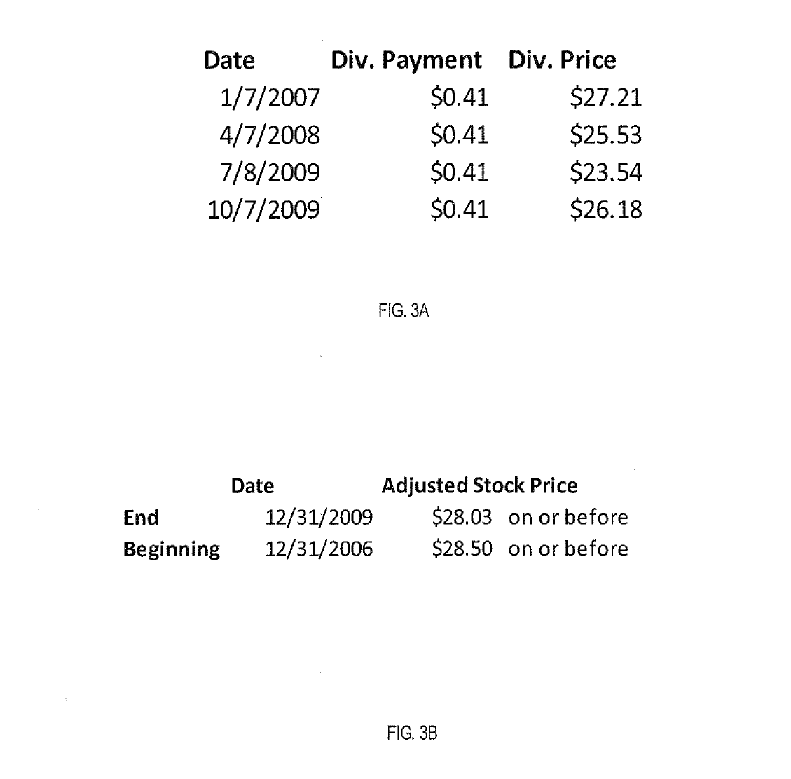

As an example of how the performance measure of a company may be calculated using the formula illustrated in FIG. 2, assume that a company “Sample Co” made the dividends illustrated in FIG. 3A (where the dividend price is the adjusted stock price on or before the dividend payment date), and had the adjusted stock prices illustrated in FIG. 3B.

Based on this raw data, the TSR for the target company, with dividend re-investment, may be calculated in the following steps:

In step #1, n₀ is calculated based on the first equation illustrated in FIG. 2. Specifically, n₀ is determined to be 100/beginning price=100/28.5=3.508772.

In step #2, the first dividend payment is determined, starting from the beginning date, Jan. 1, 2009. In the present example, the first dividend payment is $0.41 on Jan. 7, 2007. Once the first dividend payment is determined, the results from step #1 (n₀) is multiplied by the dividend payment #1 and divided by dividend price #1. This amount is then added back to n₀ to produce n₁. In the present example, the result of these operations is (3.508772*0.41)/27.21+3.508772=3.561642.

In step #3, the 2nd dividend payment starting from the beginning date is determined. In the present example, this is the $0.41 on Apr. 7, 2008. The results from step #2 (n1) are then multiplied by dividend payment #2 and divided by dividend price #2. This amount is then added back to n₁ to produce n₂. In the present example, the result of these operations is (3.561642*0.41)/25.53+3.561642=3.61884.

In step #4, the 3rd dividend payment starting from the beginning date is determined. This is the $0.41 on Jul. 8, 2009. The results from step #3 (n₂) are then multiplied by dividend payment #3 and divided by dividend price #3. This amount is then added back to n₂ to produce n₃. In the present example, the result of these operations is (3.61884*0.41)/23.54+3.61884=3.68187.

In step #5, the 4th dividend payment starting from the beginning date is determined. This is the $0.41 on Oct. 7, 2009. The results from step #4 (n₃) are then multiplied by dividend payment #4 and divided by dividend price #4. This amount is then added back to n₃ to produce n₄. In the present example, the result of these operations is (3.61884*0.41)/26.18+3.68187=3.739531.

There are no more dividends paid within this time period, so in step #6 the final TSR is calculated. Specifically, in step #6, the results from step #5 (n₄) are multiplied by price at the end of the period, Dec. 31, 2009, and then divided by initial investment of $100. TSR is then annualized by applying power to the ⅓ (for a 3-yr calculation), and then subtracting 1. In the present example, these operations produce the resulting TSR of ((3.7395318*28.03)/100)̂(⅓)-1=0.015812 or 1.6%.

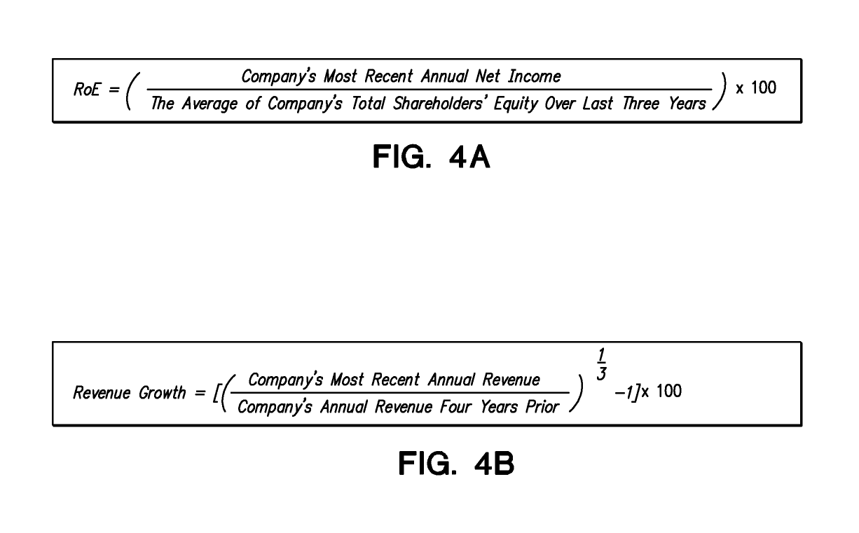

It should be noted that 3-year TSR is merely one metric that may be used to represent performance of a company. For example, the performance metric may use the TSR over a different duration, such as one year or five years. Instead of or in addition to TSR, any number of other performance metrics may be used. Such other performance metrics include, but are not limited to, the return on Three-year Average Equity (“RoE”), which may be calculated as illustrated in FIG. 4A, and the Three-year Revenue Growth, which may be calculated as illustrated in FIG. 4B.

The performance metric that is ultimately used to determine a pay-for-performance score may combine multiple sub-metrics. For example, the final performance metric may be generated by generating the average after normalizing the 3-year TSR, 3-year RoE, and Three-year Revenue Growth. In some embodiments, weighting factors may be applied to the various sub-metrics, to give more weight to some factors relative to other factors in the final performance metric.

### Executive Pay Measures

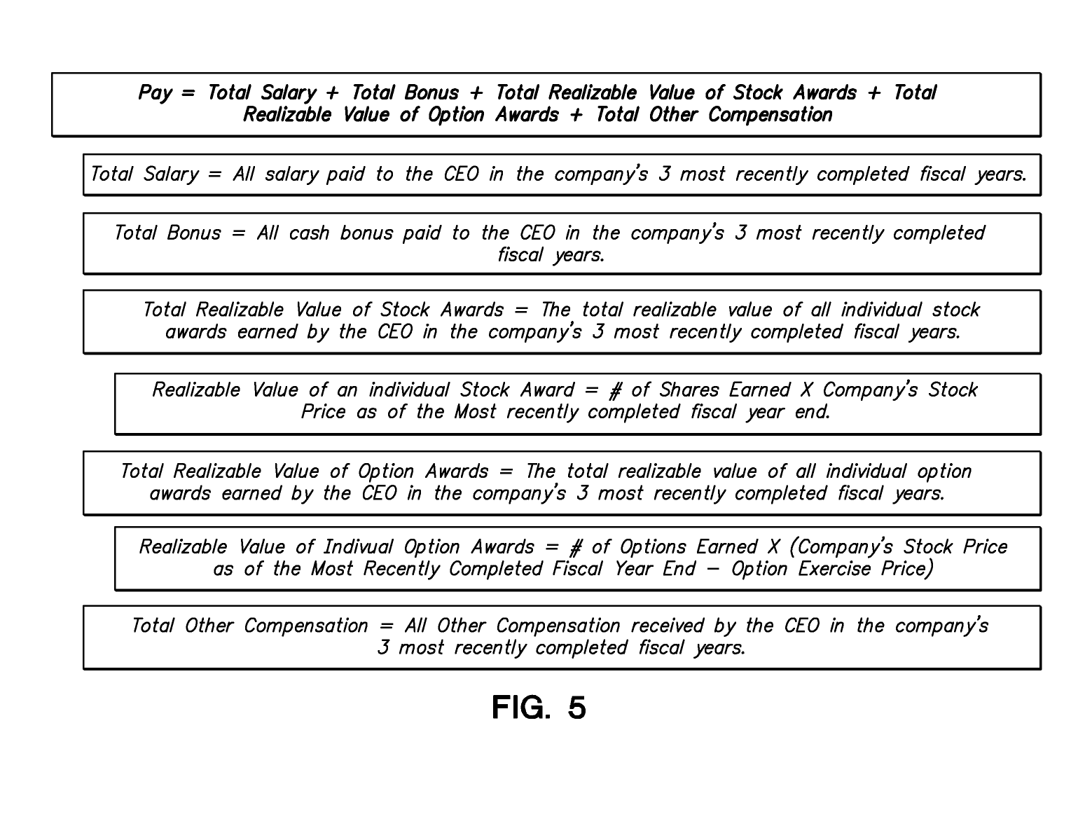

Executive payment arrangements may be simple (e.g. salary), or complex (e.g. salary +stock +options etc.). The better the pay metric is able to capture the value of all compensation received by an executive, the more accurate the pay-for-performance score will be. FIG. 5 gives one example of how a pay metric for an executive (in this case, the CEO) may be generated, according to an embodiment of the invention.

Referring to FIG. 5, the formula illustrated therein uses, as raw data points, the CEO's salary, the CEO's cash bonus, the CEO's stock awards, the CEO's option awards, other compensation received by the CEO, and the fiscal year end stock price. It should be noted that all of these amounts, other than the fiscal year end stock price, are available from Form DEF14A that companies are required to file with the U.S. Securities and Exchange Commission (“SEC”). The fiscal year end stock price is publicly available from many sources.

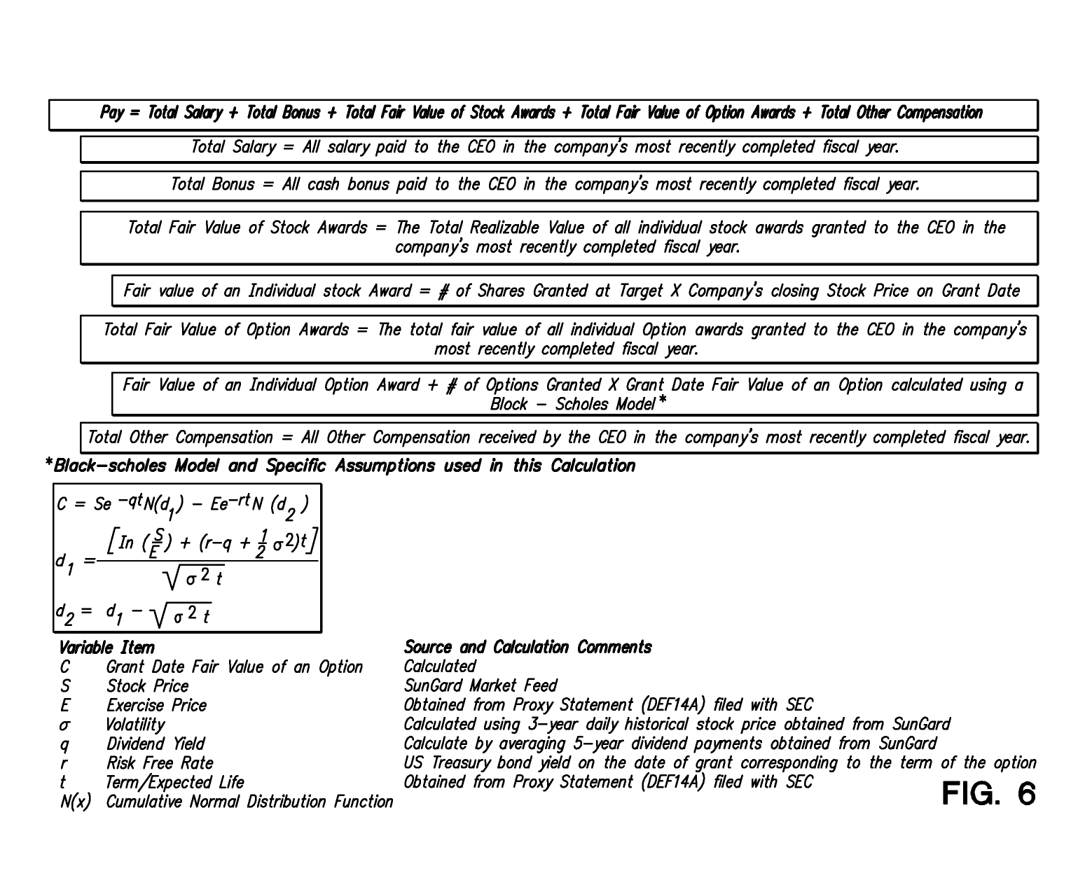

FIG. 6 illustrates an alternative technique for calculating executive compensation. The technique illustrated in FIG. 6 is for a 1-year grant date pay, and makes use of the Black-Scholes Model to calculate the grant date fair value of an option. FIG. 6 also indicates sources from with the various raw values may be obtained.

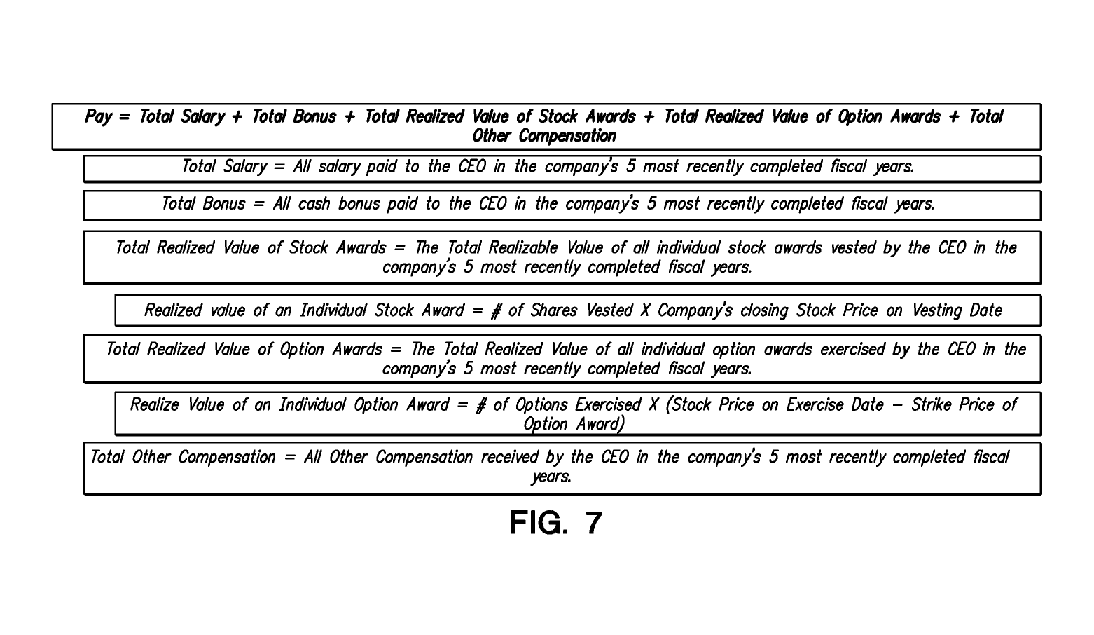

FIG. 7 gives yet another example of how the pay metric of an executive may be generated, according to an embodiment. The technique illustrated in FIG. 7 generates the pay metric based on the 5-year realized pay of the executive.

The techniques for generating the pay factor of the pay-for-performance score that are illustrated in FIGS. 5-7 are merely examples, and the pay-for-performance score is not limited to any particular technique for generating the pay factor.

### Practical Applications

There are any number of practical applications for which the pay-for-performance score may be used. For example, in one embodiment, a pay-for-performance score is generated for each publicly traded company in the Russell 3000 index, and may be used by company directors, market analysts and/or investors as a basis for determining whether a particular executive for a particular company is being overcompensated or undercompensated.

The pay-for-performance score may also be calculated for public traded companies in other indices or markets, including but not limited to the S&P500, S&P/TSX Composite (Toronto Stock Exchange), FTSE 100 (London Stock Exchange), etc.

### Automated Generation of Pay-For-Performance Scores

According to embodiments of the invention, the generation of pay-for-performance scores is automated by causing one or more computer systems (described in greater detail below) to execute the operations required to generate the performance factor, the pay factor, and the pay-for-performance scores that are based on the performance and pay factors. The raw data from which the pay and performance factors are generated may be stored in a database, such as a relational database managed by a database management system. The database may be populated by values obtained electronically over a network from external sources, and/or entered manually.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

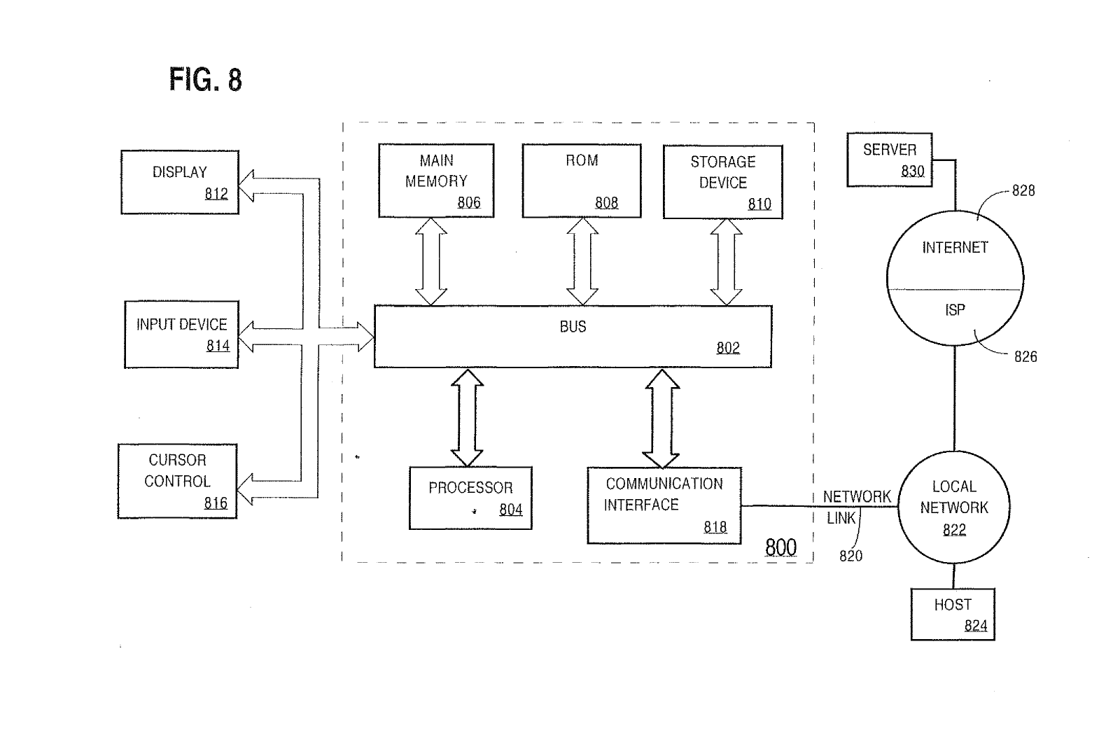

For example, FIG. 8 is a block diagram that illustrates a computer system 800 upon which an embodiment of the invention may be implemented. Computer system 800 includes a bus 802 or other communication mechanism for communicating information, and a hardware processor 804 coupled with bus 802 for processing information. Hardware processor 804 may be, for example, a general purpose microprocessor.

Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk or optical disk, is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 810. Volatile media includes dynamic memory, such as main memory 806. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
identifying a plurality of peers of a target entity to which a target executive belongs;
generating a pay-for-performance score for the target executive based, at least in part, on:
a first performance factor generated for the target entity that reflects performance of the target entity during a first particular time period;
a plurality of second performance factors, wherein each of the plurality of second performance factors is generated for a different one of the plurality of peers of the target entity and reflects performance of the corresponding peer during the first particular time period;
a first pay factor generated for the target executive that reflects payment received by the target executive during a second particular time period; and
a plurality of second pay factors, wherein each of the plurality of second pay factors is generated for a different executive from one of the plurality of peers of the target entity and reflects pay received by the corresponding executive during the second particular time period;
wherein the step of generating a pay-for-performance score is performed by one or more computing devices.

2. The method of claim 1 wherein the first particular time period is the same as the second particular time period.

3. The method of claim 1 wherein generating the pay-for-performance score includes subtracting the lowest of the plurality of second performance factors from the first performance factor.

4. The method of claim 3 wherein:
generating the pay-for-performance score includes dividing the difference between the first performance factor and the lowest of the plurality of second performance factors by a particular value; and
the particular value is the highest of the plurality of second performance factors minus the lowest of the plurality of second performance factors.

5. The method of claim 1 wherein generating the pay-for-performance score includes subtracting the lowest of the plurality of second pay factors from the first pay factor.

6. The method of claim 5 wherein:
generating the pay-for-performance score includes dividing the difference between the first pay factor and the lowest of the plurality of second pay factors by a particular value; and
the particular value is the highest of the plurality of second pay factors minus the lowest of the plurality of second pay factors.

7. The method of claim 1 wherein generating the pay-for-performance score includes subtracting one plus the median of the plurality of second performance factors from one plus the first performance factor.

8. The method of claim 7 wherein:
generating the pay-for-performance score includes dividing the difference between one plus the first performance factor and one plus the median of the plurality of second performance factors by a particular value; and
the particular value is one plus the median of the plurality of second performance factors.

9. The method of claim 1 wherein generating the pay-for-performance score includes subtracting the median of the plurality of second pay factors from the first pay factor.

10. The method of claim 9 wherein:
generating the pay-for-performance score includes dividing the difference between the first pay factor and the median of the plurality of second pay factors by a particular value; and
the particular value is the median of the plurality of second pay.

11. The method of claim 1 further comprising generating the first performance factor based on total shareholder return for the target entity during the first particular time period.

12. The method of claim 1 further comprising generating the first performance factor based on return on equity for the target entity during the first particular time period.

13. The method of claim 1 further comprising generating the first performance factor based on revenue growth of the target entity during the first particular time period.

14. The method of claim 1 further comprising generating the first performance factor based on a combination of at least two of:
total shareholder return for the target entity during the first particular time period;
revenue growth of the target entity during the first particular time period; and
return on equity for the target entity during the first particular time period.

15. A non-transitory computer-readable medium storing instructions which, when executed by one or more computing devices, cause performance of a method comprising:
generating a pay-for-performance score for a target executive based, at least in part, on:
a first performance factor generated for a target entity to which the target executive belongs, wherein the first performance factor reflects performance of the target entity during a first particular time period;
a plurality of second performance factors, wherein each of the plurality of second performance factors is generated for a different one of a plurality of peers of the target entity and reflects performance of the corresponding peer during the first particular time period;
a first pay factor generated for the target executive that reflects payment received by the target executive during a second particular time period; and
a plurality of second pay factors, wherein each of the plurality of second pay factors is generated for a different executive from one of the plurality of peers of the target entity and reflects pay received by the corresponding executive during the second particular time period.

16. The non-transitory computer-readable medium of claim 15 wherein the first particular time period is the same as the second particular time period.

17. The non-transitory computer-readable medium of claim 15 wherein generating the pay-for-performance score includes subtracting the lowest of the plurality of second performance factors from the first performance factor.

18. The non-transitory computer-readable medium of claim 17 wherein:
generating the pay-for-performance score includes dividing the difference between the first performance factor and the lowest of the plurality of second performance factors by a particular value; and
the particular value is the highest of the plurality of second performance factors minus the lowest of the plurality of second performance factors.

19. The non-transitory computer-readable medium of claim 15 wherein generating the pay-for-performance score includes subtracting the lowest of the plurality of second pay factors from the first pay factor.

20. The non-transitory computer-readable medium of claim 19 wherein:
generating the pay-for-performance score includes dividing the difference between the first pay factor and the lowest of the plurality of second pay factors by a particular value; and
the particular value is the highest of the plurality of second pay factors minus the lowest of the plurality of second pay factors.

21. The non-transitory computer-readable medium of claim 15 wherein generating the pay-for-performance score includes subtracting one plus the median of the plurality of second performance factors from one plus the first performance factor.

22. The non-transitory computer-readable medium of claim 21 wherein:
generating the pay-for-performance score includes dividing the difference between one plus the first performance factor and one plus the median of the plurality of second performance factors by a particular value; and
the particular value is one plus the median of the plurality of second performance factors.

23. The non-transitory computer-readable medium of claim 15 wherein generating the pay-for-performance score includes subtracting the median of the plurality of second pay factors from the first pay factor.

24. The non-transitory computer-readable medium of claim 23 wherein:
generating the pay-for-performance score includes dividing the difference between the first pay factor and the median of the plurality of second pay factors by a particular value; and
the particular value is the median of the plurality of second pay.

25. The non-transitory computer-readable medium of claim 15 wherein the method further comprises generating the first performance factor based on total shareholder return for the target entity during the first particular time period.

26. The non-transitory computer-readable medium of claim 15 wherein the method further comprises generating the first performance factor based on return on equity for the target entity during the first particular time period.

27. The non-transitory computer-readable medium of claim 15 wherein the method further comprises generating the first performance factor based on revenue growth of the target entity during the first particular time period.

28. The non-transitory computer-readable medium of claim 15 wherein the method further comprises generating the first performance factor based on a combination of at least two of:
total shareholder return for the target entity during the first particular time period;
revenue growth of the target entity during the first particular time period; and
return on equity for the target entity during the first particular time period.
